(19) United States
(12) Patent Application Publication
(10) Pub. No.: US 2006/0290488 A1
(43) Pub. Date: Dec. 28, 2006

(54) Coding module and sensing meter and system therefor

(75) Inventor: Chun-Mu Huang, Sanchung City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: BioNime Corporation, Dali City (TW)

(21) Appl. No.: 11/441,880

(22) Filed: May 26, 2006

(30) Foreign Application Priority Data
May 27, 2005 (TW) 94117601

(51) Int. Cl. H04Q 1/30

(52) U.S. Cl. 340/537

(57) ABSTRACT

A coding module, a sensing meter and a sensing system are provided in the present application. The coding module is used to define a code for ciphering a parameter value employed in controlling an operation of the sensing meter. The code is exhibited by an electrical component having a determined characteristic, preferably, a resistance value.

### FIELD OF THE INVENTION

The invention mainly relates to a sensing meter for determining a presence of an analyte in a biological sample, and, more particularly, to a sensing meter whose operation is controlled by a code provided by a removable and pluggable coding module. The invention further relates to a removable coding module for the sensing meter and used for receiving a sample strip. The coding module defines at least one code, and the code ciphers at least one parameter value that is employed in controlling the operation of the sensing meter.

### BACKGROUND OF THE INVENTION

Sensing meters for detecting substances contained in the blood to be analyzed, such as glucose or cholesterol, normally include a disposable sample strip. The disposable sample strip has a reaction zone to allow blood placed thereon. The relevant operations of the sensing meter are controlled by a microprocessor. By execution of various procedures, analysis results of the measurement could be obtained.

Nevertheless, it is normally necessary to calibrate the instrumentation used in connection with test device (such as the bio sensing meter) in order to compensate the variations on the sample strips manufactured in different batches. Various techniques have been suggested for encoding information into the sample strip, such as U.S. 5,053,199 and references cited therein. In the prior arts, the technique for encoding information includes a usage of the electronically encoded information on a carrier having an optical bar code, a magnetizable film, a perforated strip, a fluorogens or an electrically conductive medium on a foil. The conventional sample strips are always furnished with an information code, which costs an additional and expensive effort for a disposable device.

In addition, the conventional sensing meter uses an additional coding module or a code key designed and inserted into a receptacle similar to the slot for the sample strip. While performing a measurement, a code key has to be inserted in the sensing meter all the time for the same batch of sample strips. According to the data and the code provided by the coding module, i.e. the code key, the operation procedure and parameter are selected and a correct measurement result could be obtained.

U.S. Pat. No. 5,366,609 and documents cited therein disclosed the bio sensing meters having pluggable coding modules that enable reconfiguration of the test procedures and parameters employed by the sensing meters. Threshold potentials, test times, delay periods and other pertinent test procedures and constants may be entered and/or altered.

The main purpose of the coding module is to provide information about the type of sample strip. Therefore, for each new batch of sensor strips, new related information is needed. In order to perform the sample measurement and the analysing routines, the sensing meter needs certain parameter values which determine thresholds, time intervals, control numbers and calibration curve attributes. The controlling process could be named as measurement method, and when a parameter of the controlling process is changed, it could be considered as a different measurement method. As sample strips are disposable, preferably coding modules are disposable too. Nevertheless, costs for the coding modules are always the effecting factors.

As above, a new invention capable of overcoming the drawbacks of the prior arts, especially avoiding the usage of memory IC chip technology for storing codes on coding modules, providing a coding module and a bio sensing meter with pluggable coding module, which has a simple design, and being produced with lower costs is expected at present.

### SUMMARY OF THE INVENTION

In accordance with the present invention a coding module is presented, which includes at least one code, wherein the at least one code is exhibited by a parameter value of at least one electrical component having a determined characteristic, preferably a resistor, a switch or a capacitor.

Electrical components can have various measurable characteristics, such as electrical characteristics, e.g. resistance, capacitance or impedance. The advantage of using electrical characteristics of a component for encoding information is that no additional measurement device, for example an optical or magnetic detector, is necessary in the relevant sensing meter. Usually the sensing meter provides means for performing a voltage and/or current measurement for analyzing the analyte concentration, the same measurement tools can be used for reading the code. Electrical components such as resistances are not expensive.

It is a simple technique suitable for coding information to measure a resistance, like in the present case, where e.g. only one code number or a few parameter values have to be identified. Contrary to the state of the art IC chip technology, no integrated circuits are needed. Macroscopic electrical components can be used.

Preferably, the coding module of the present application includes at least a resistor, which is inexpensive and can be measured easily. A resistor is a simple implementation of non-volatile information carrier. Since a broad variety of standard resistor is available, a big number of codes can be exhibited only by the value of the relevant resistances. A greater number of possibilities for encoding could be achieved, when the at least one code is exhibited by a plurality of resistances, e.g. one to six, preferably four resistances.

It is turned out that 2 different resistance values on four to seven places, resulting in 16 to 24 different codes, provide enough information to control the analysing process.

Preferably, the code contains information regarding the sample strip batch. Sample strips should always be used with a relevant coding module. In order to reduce the error rate and to protect the slot of the sensing meter from a contamination resulting from the analyte or a biologic sample, in a preferred embodiment, the coding module has a receptacle serving as a sample strip.

Usually, the sample strip includes a plurality of electrodes, for applying and/or measuring a voltage and/or a current.

In a preferred embodiment of the present application, the coding module includes means for establishing an electrical contact between the sensing meter and the sample strip.

The coding module allows for a direct connection of the sample strip electrodes and the contacts of the sensing meter, for example by providing a recess or a hole in the area of the connection zone.

Alternatively, the coding module may have contacts connecting the sample strip electrodes with the sensing meter contacts. According to another aspect of the present invention, a sensing meter is provided in connection with a pluggable coding module with at least one code. The sensing meter has an electrical receptacle serving as a pluggable coding module and includes means for receiving information from the coding module defining at least one code. The code is exhibited by at least one electrical component having a determined characteristic, preferably a resistance.

The coding module is preferably of the above described type, wherein the code is exhibited by at least one, typically one to six, in particular four resistances and/or selected from a variety of different resistances. The at least one resistance can also be formed by at least one resistor. The sensing meter is provided with information about the sample batch by the code on the coding module.

The code can be a simple binary code, exhibited by one or more resistances interpreted as one of two sets of parameter values stored in the sensing meter or defining a binary code. Each resistance forms a bit. The encoding can be made more complex by using a wider range of resistance values or a bigger number of resistances.

In a preferred embodiment, the parameter value is correlated to the value of the at least one resistance. The parameter may also be encoded by the value and the order of at least two resistances, in particular by the order of four resistance values. In a preferred embodiment, the coding module only hosts the code exhibited by the resistances. The value of the at least one resistance and/or the order of at least two resistances could be detected by a microprocessor routine performed by the sensing meter.

The generation of the code based on the resistance measurements and the translation of the code into parameter values are performed by the sensing meter. The coding module is only a carrier of the code. The sensing meter has the capability of reading the code, decoding and using the information.

The code can be derived from the resistance measurement by correlating the measured values, such as the resistances, currents or voltages, with code numbers. The code can also be formed by the resistance values. The parameter values can be derived from the code by a microprocessor routine.

In a preferred embodiment the at least one code is decoded by extracting parameter values via using a look-up table stored in a memory of the sensing meter.

This memory can be a read only memory. It can also be exchangeable or it can be rewritable, so that the look-up table can be exchanged or updated accordingly.

The sensing meter may have different receptacles for the sample strips, the coding module and a calibration module.

In a preferred embodiment of the present application, the electrical receptacle is able to accept the coding module and is also able to accept the calibration module.

A single electrical receptacle is user friendly because of the less error possibility, and electrical circuits can be framed more effectively.

A further concept is achieved by providing a coding module having a receptacle able to accept sample strip.

Accordingly, the receptacle able to accept the coding module is also a receptacle for the sample strip, without the direct contact with the sample strip.

For sample strips including electrodes, the coding module enables the electrical coupling between the sensing meter and sample strips.

According to a further aspect of the present application, a sensing system for analysing an analyte is provided. The sensing system includes a coding module with at least one code, preferably of the above described type and a sensing meter, preferably of the above described type, with means for receiving the at least one code from the coding module. The code ciphers at least one parameter value used in controlling the operation of the sensing meter, for example in controlling the execution of an algorithm performed by the sensing meter that enables a determination of an analyte concentration value. The at least one code is exhibited by at least one electrical component having a determined characteristic, e.g. a resistance.

According to a further aspect of the present application, a sensing test set is provided. The sensing test set includes at least one test strip and a coding module with at least one code, preferably of the above described type, pluggable into a sensing meter.

The at lease one code ciphers at least one parameter value used in controlling the operation of the sensing meter, for example in controlling the execution of an algorithm performed by the sensing meter that enables a determination of an analyte concentration value. The at least one code is exhibited by at least one electrical component having a determined characteristic, e.g. a resistance.

Usually, a sensing test set having one coding module and a plurality of sample strips form a commercial unit which is sold together in one package.

According to a further aspect of the present application, a method for operating a sensing meter, preferably of the above described type, is provided. The method including the steps of (i) inserting a coding module with at least one code into the sensing meter, (ii) detecting the at least one code, (iii) determining at least one parameter value used for controlling an operation of the sensing meter, (iv) inserting a sample strip and adding a sample thereon, (v) analysing the sample on the basis of the at least one parameter value, whereby the at least one code is exhibited by at least one electrical component having a determined characteristic, e.g. a resistance.

The above contents and the advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a perspective view of an example of a bio sensing meter according to a preferred embodiment of the present application;

FIG. 2a is a perspective bottom view of a coding module according to a preferred embodiment of the present application;

FIG. 2b is a perspective top view of a coding module according to a preferred embodiment of the present application;

FIG. 3a is an exploded top view of a coding module according to a preferred embodiment of the present application;

FIG. 3b is exploded bottom view of a coding module according to a preferred embodiment of the present application;

FIG. 4 shows the relation between analyte concentration and a measuring current according to a preferred embodiment of the present application;

FIG. 5a is a schematic representation of a first embodiment of the present invention;

FIGS. 5b and 5c are different tables showing coding information according to the first preferred embodiment of the present application;

FIG. 6a is a schematic representation of a second embodiment of the present invention;

FIGS. 6b and 6c show tables with coding information according to the second preferred embodiment of the present application; and

FIG. 7 is a schematic representation of a third embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

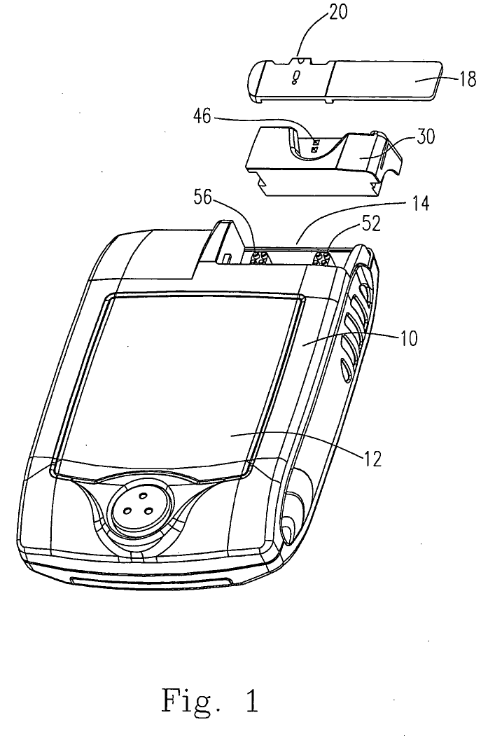

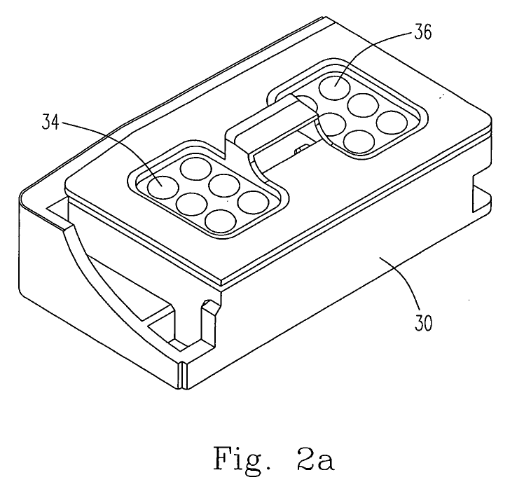

Please refer to FIG. 1, which is a bio sensing meter according to a preferred embodiment of the present application. The bio sensing meter 10 has a display 12, and is able to get in contact with a disposable sample strip 18. The sample strip 18 has conductive electrodes (not shown). An enzymatic reactant layer (not shown) is formed in the reaction zone to cover the electrodes. An analyte-containing fluid, for example, a drop of blood, can be dripped on the substance entrance 20.

The bio sensing meter 10 further has a plug-in coding module 30, which is inserted into a slot 14 of the bio sensing meter 10 to be electrically connected thereto and to establish a mutual communication therebetween.

The coding module 30 has a receptacle 46 able to accept the sample strip 18.

The coding module 30 is electrically connected between the bio sensing meter 10 and the sample strip 18. When the coding module 30 is plugged into the slot 14 of the bio sensing meter 10, contacts 52 of the bio sensing meter 10 would be electrically contacted with the electrodes of the sample strip 18 inserted in the coding module 30.

The coding module 30 contains electrical components not explicitly shown in FIG. 1, which are connectable to the contacts 56 of the bio sensing meter 10.

Alternatively, the bio sensing meter 10 may have two slots, one for accepting the sample strip 18 and a further one for accepting the coding module 30.

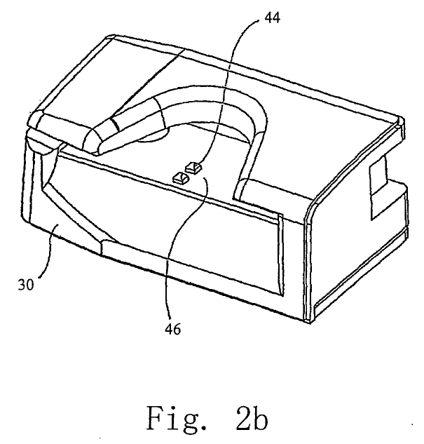

Please refer to FIGS. 2a and 2b, where the coding module 30 is shown therein.

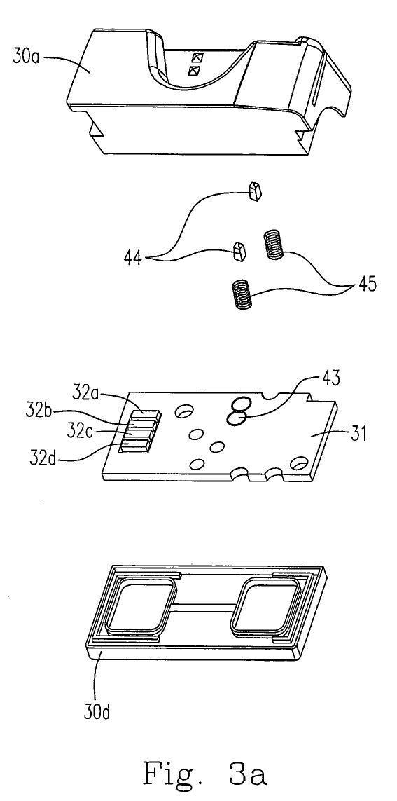

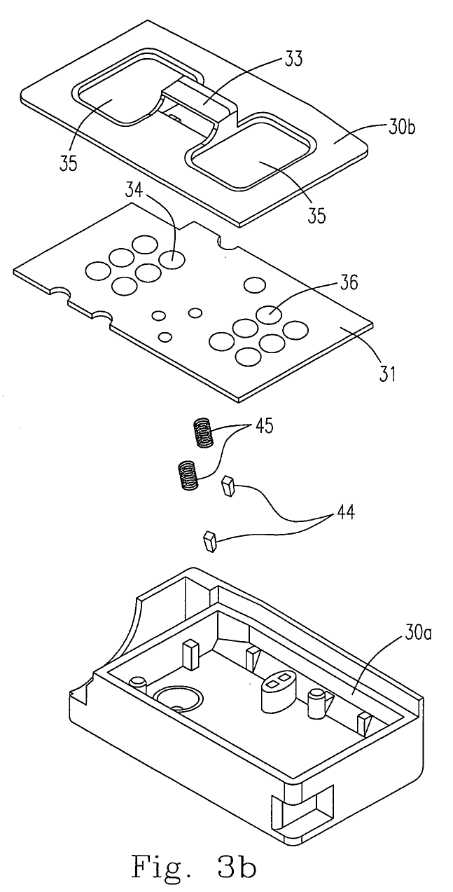

Please refer to FIGS. 1, 2a-2b, 3a and 3b, after the coding module 30 is inserted into the bio sensing meter 10, the contacts 56 of the bio sensing meter 10 are in connection with contacts 36, such that the resistance values of the resistors 32a, 32b, 32c and 32d (see FIG. 3a) can be detected. The coding module 30 has to be inserted in the bio sensing meter 10 at least once before the relevant measurement or permanently.

The contacts 34 of the coding module 30 get in contact with the contacts 52 of the bio sensing meter 10 so that characteristics of the sample on the sample strip 18 can be measured.

The chemistries used for the sample strips and analyte determination algorithms are known in the art. They will not be described in detail hereinafter.

As an example, the analyte-containing sample may be a drop of blood that is subjected to a glucose determination. A disposable sample strip for a glucose determination will include, in a reaction zone, chemical reagents, basically an enzyme, such as a glucose oxidase and a redox mediator, such as a potassium ferricyanide.

As shown in FIG. 2b, within the receptacle 46, there are contacts 44 which are electrically connected to the contacts 34. Upon an insertion of the sample strip 18 in the receptacle 46, the electrodes (not shown) of the sample strip 18 get in contact with the contracts 44.

FIGS. 3a and 3b show an upper and lower exploded view of the coding module 30. The coding module 30 is formed by a upper part 30a and a lower part 30b. A printed circuit board 31 is arranged between the upper part 30a and the lower part 30b. Resistors 32a, 32b, 32c and 32d are arranged on the printed circuit board 31 and are able to cipher a code as will be described hereinafter. Contacts 44 are arranged between the printed circuit board 31 and the upper part 30a. Springs 45 are arranged on spring contact pads 43. The springs 45 are used to hold the contacts 44 in good contacts against the electrodes of the sample strip 18.

Please refer to FIG. 3b showing an exploded bottom view of the coding module 30. The bottom part 30b is provided with a lock 33 for positioning and holding the coding module 30 in the bio sensing meter 10. The bottom part 30b includes holes 35 through which the contacts 34 and 36 of the printed circuit board 31 may be in contact the contacts 52, 56 of the bio sensing meter 10 (referring to FIG. 1). The upper part 30a and the lower part 30b are formed of a plastic material, typically in an injection moulding.

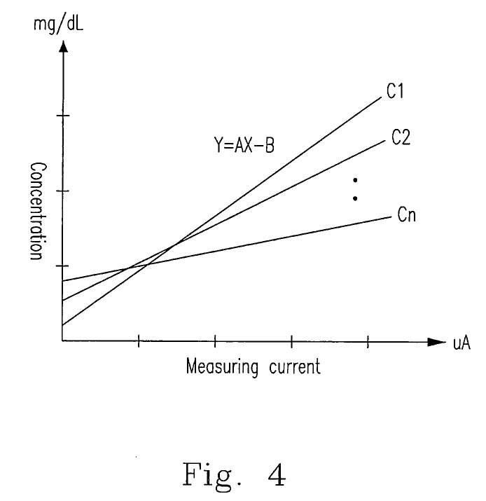

FIG. 4 shows a diagram of a curve of the concentration of the analyte in the sample, in particular the glucose in the blood, in relation to the measuring currents determined by the bio sensing meter. The concentration linearly depends on the measuring current. The concentration may be given by the formula Y=AX−B. The parameters A and B, however, depend on several conditions, in particular on the reactant composition which is used. Depending on the manufacturing process and depending on specific reactant compositions of the different batches of sample strips, different slopes (factor A) and different off-sets (factor B) may be applicable. The different relations are characterised by several codes C1, C2, . . . Cn which are associated to specific manufacturing batches. The coding module according to the present application in particular may be used for coding the codes C1 to Cn. It may, however, also be used for coding different analyte types or different measurement methods.

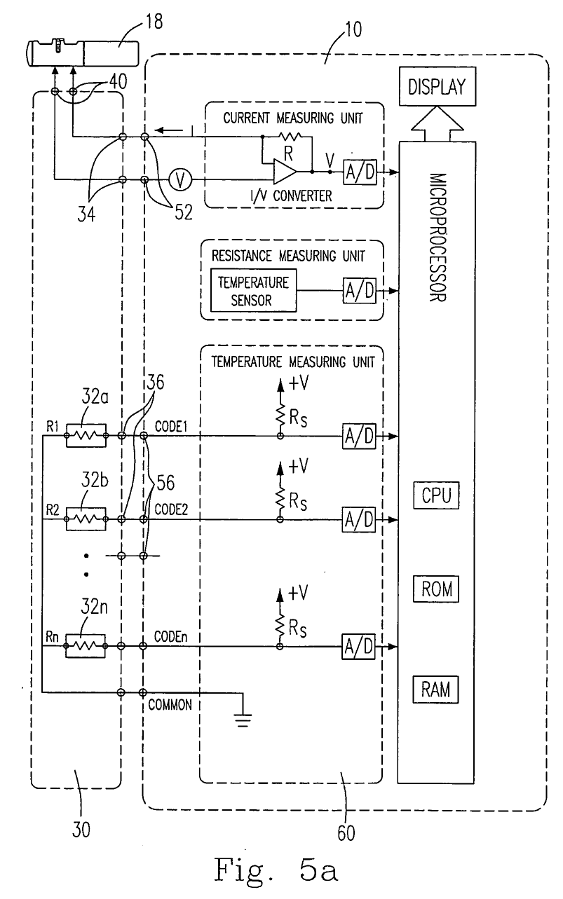

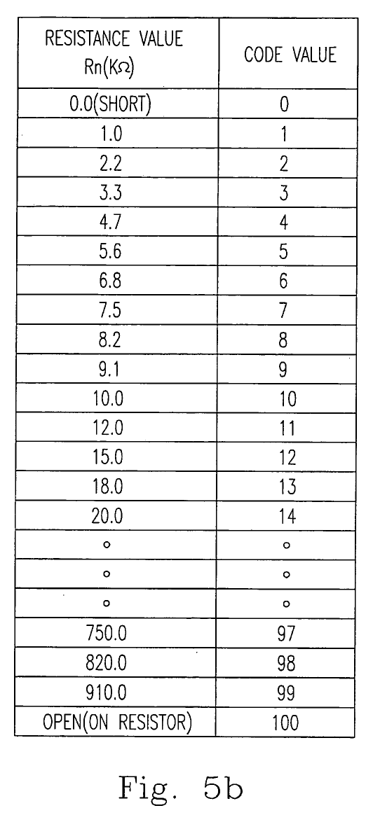

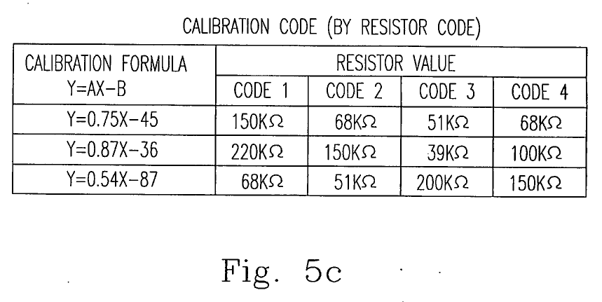

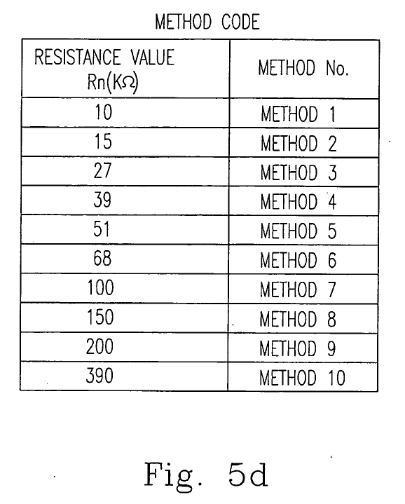

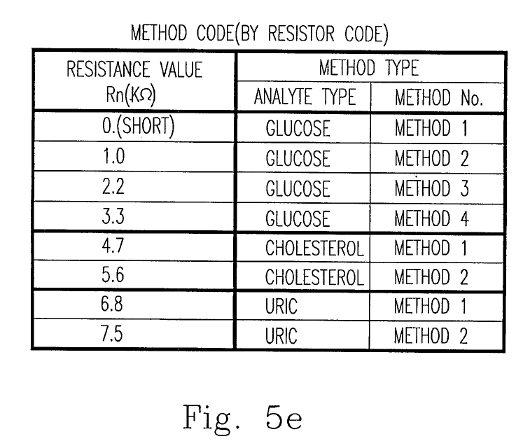

FIG. 5a shows a schematic view of a bio sensing meter 10 with a coding module 30 according to the present invention and with a test sample strip 18. The bio sensing meter 10 includes the standard components, such as a microprocessor with a central processing unit, a read-only memory (ROM) and a random accessible memory (RAM), a display, a current measuring unit, an electrode working voltage supply unit (not shown) and a temperature measuring unit. These components are standard in state of the relevant art devices. In addition, the bio sensing meter 10 further includes a resistance measuring unit 60 which on the one hand is in operative connection with the coding module 30. The resistors 32a to 32n have specific resistance values R1, R2, . . . Rn and cipher certain codes as will be shown hereinafter. The determination of the resistance value is made in a manner known to one skilled in the art, in particular by measuring a current flowing through the relevant resistor if a pre-defined potential is applied to the resistor. Analog/digital converters are used to transmit the resistance values to the microprocessor.

The contacts 36 on the coding module 30 get in electrical contact with the contacts 56 on the bio sensing meter 10. In a similar manner, contacts 52 of the bio sensing meter 10 are brought into electrical contact with the contacts 34 of the coding module 30 and consequently with the pins 40 and the electrodes of the sample strip 18.

FIG. 5b shows a resistor table. If only one single resistor is used, different resistance values may be used for defining several codes, in particular codes for different linear relationships as shown in FIG. 4. Typically, one hundred different code values may be encoded with resistance values in the range between 0 KΩ (short circuit) and 910 KΩ. In addition, one further code may be defined by an open circuit.

Instead of directly coding certain codes, it is also possible to code the parameter values A, B of the linear relationship as shown in FIG. 4. FIG. 5c shows a table where four different resistors are used for defining four codes. A quadruplet of resistance values is used to define specific values for the parameters A, B. For example, the resistance value sequence 150 KΩ/68 K Ω/51 KΩ/68 KΩ is used to define a slope A of 0.75 and a off ser B of −45.

Furthermore, it is also possible to code different calculations or measurement methods. Typically, incubation times or other process parameters may depend on a batch of the sample strips. Therefore, several, such as ten, standard measurement methods may be used. FIG. 5d shows a table where different resistance values between 10 KΩ and 390 KΩ are used to code for one of the ten several standard measurement methods.

Please refer to FIGS. 5a to 5e. The first resistor 32a shown in FIG. 5a could be used for coding the code values shown in FIG. 5b and the second resistor 32b could be used for coding the method shown in FIG. 5d.

In an alternative embodiment, it is also possible to code different analyte types with a coding module 30. In the table shown in FIG. 5e, three different analyte types are coded in context with a plurality of measurement methods by the use of eight different resistance values.

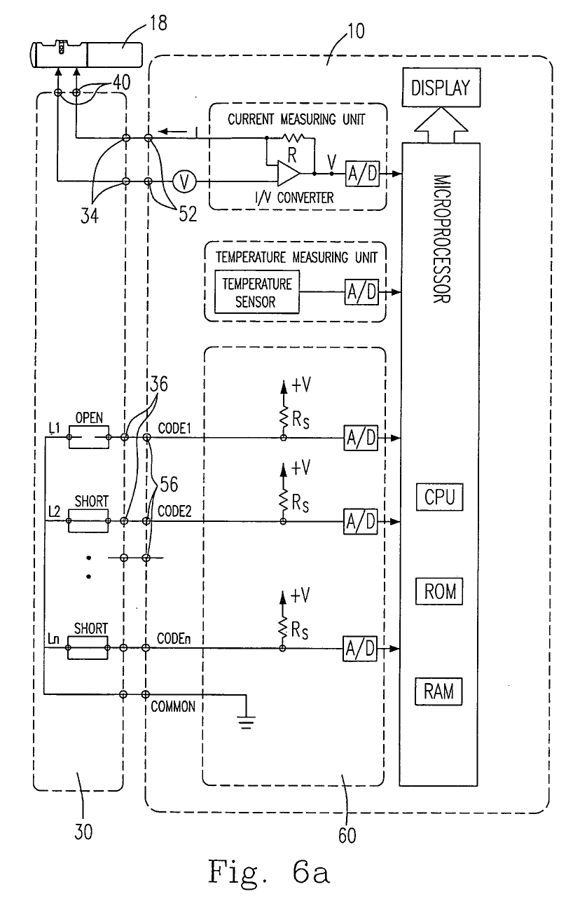

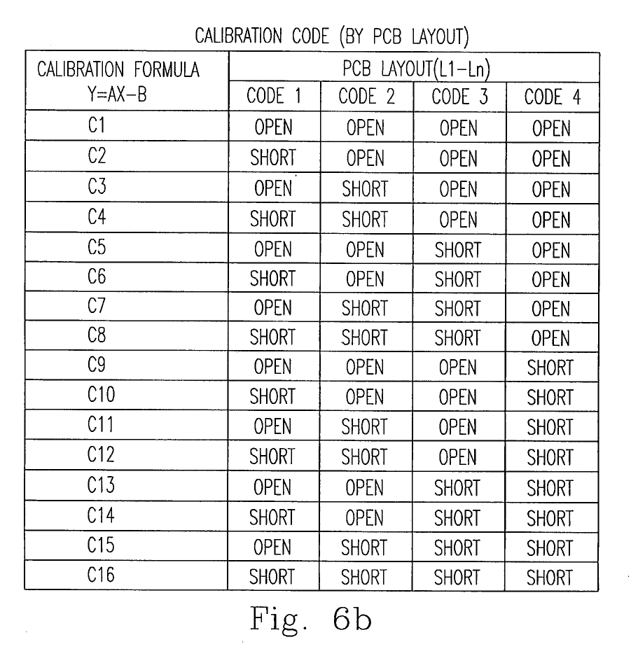

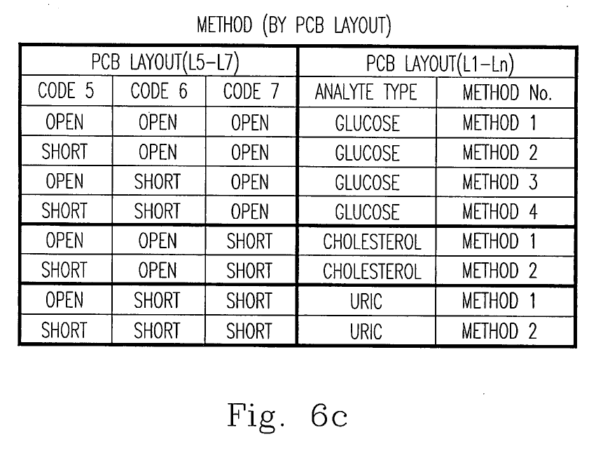

FIG. 6a shows an alternative embodiment for a coding module 30. The sample strip 18 and the sensing meter 10 are built identically to the one shown in FIG. 5a. For coding, instead of resistances having different values, a plurality of open or short circuits are used. These open or short circuit connections L1, L2, . . . Ln or switch code values such as “1” or “0” form a binary code. Such open or short circuit connections may be easily arranged on the PCB layout. The determination of the resistance value is made in a similar way as explained with reference to FIG. 5a.

FIG. 6b shows a table where different calibration formulas according to 16 different codes are coded with a 4-bit arrangement of open or short circuit connections defining code 1, code 2, code 3 and code 4. Four binary codes allow the definition of 16 different calibration formulas.

In FIG. 6c, a method code of 3 bit coding for coding different analyte types or methods is shown. Three additional open or short circuit connections L5, L6 and L7 define six further codes which may describe eight combinations of the analyte and measurement methods.

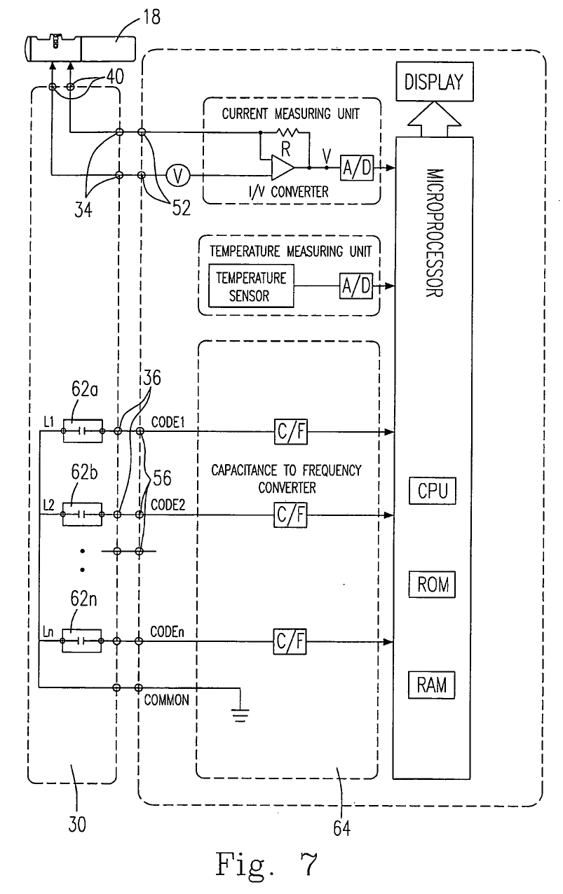

FIG. 7 shows a coding module according to another preferred embodiment of the present application. Instead of resistors as shown in FIG. 5a, capacitors 62a, 62b . . . 62n having different capacitances C1, C2, . . . Cn are used for defining a code. Instead of a resistance measurement unit as shown in FIG. 5a, a capacitance measuring unit 64 is used in the embodiment as shown in FIG. 7. Capacitance to frequency converters are used for providing a coding signal to the microprocessor.

Coding module 30 thus may include a variety of data that are used in operation of bio sensing meter 10. Those data encompass, such as measurement delay times, the incubation time, the number of measurements to be taken during a measurement period, thresholds against which voltage levels are to be compared, values of excitation voltage levels to be applied to sample strip 18 during a test procedure, and the glucose value conversion factors. In addition, although the above preferred embodiments relate to the bio sensing meter, it should be noted that the present application could also relate to other sensing meter and system.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A coding module detachably connected with a sensing meter for receiving a sample strip, comprising a first passive electrical component having a first determined characteristic defining a first code ciphering a first parameter value used in an operation of said sensing meter.

2. A coding module according to claim 1, wherein said first passive electrical component is one selected from the group consisting of a resistor, a capacitor, an open circuit connection and a short circuit connection.

3. A coding module according to claim 2, wherein said resistor has a resistance value ranged from 1KΩ to 1MΩ.

4. A coding module according to claim 1, wherein said first code is exhibited by one to six resistors.

5. A coding module according to claim 4, wherein said first code is exhibited by four resistors.

6. A coding module according to claim 1, wherein said coding module has a receptacle receiving said sample strip.

7. A coding module according to claim 6, wherein said coding module comprises a device electrically coupled between said sensing meter and said sample strip.

8. A sensing meter, comprising an electrical receptacle receiving a coding module as claimed in claim 1.

9. A sensing meter according to claim 8, further comprising a first device receiving an information defining a second code from said coding module.

10. A sensing meter according to claim 9, wherein said second code is exhibited by a second parameter value of a second passive electrical component having a second determined characteristic.

11. A sensing meter according to claim 10, wherein said determined characteristic is a resistance value.

12. A sensing meter according to claim 11, further comprising a second device to measure said resistance value.

13. A sensing meter according to claim 9, further comprising a memory having a look-up table for decoding said second code and/or extracting said second parameter value.

14. A sensing system for analysing an analyte, comprising:
a coding module defining a code; and
a sensing meter having a first device receiving said code from said coding module,
wherein said code is used to cipher a parameter value used in controlling an operation of said sensing meter, and said code is exhibited by a passive electrical component having a determined characteristic.

15. A sensing system according to claim 14, wherein said passive electrical component is one selected from the group consisting of a resistor, a capacitor, an open circuit connection and a short circuit connection.

16. A sensing system according to claim 14, wherein said determined characteristic is a resistance value.

17. A sensing test set comprising:
a test strip with an analyte reactant thereon; and
a coding module pluggable into a meter,
wherein said coding module defines a code ciphering a parameter value employed in controlling an operation of said meter and said code is exhibited by a passive electrical component having a determined characteristic.

18. A sensing test set according to claim 17, wherein said determined characteristic is a resistance value.

19. A sensing test set according to claim 17, wherein said operation is an execution of an algorithm performed by said meter.

20. A method for operating a meter, comprising steps of:
(i) inserting a coding module with a code into said meter;
(ii) detecting said code;
(iii) determining a parameter value on a basis of said code; and
(iv) analysing a sample on a basis of said parameter value,
wherein said code is exhibited by a passive electrical component having a determined characteristic.

21. A method according to claim 20, wherein said determined characterisitic is a resistance value.
